(19) United States
(12) Patent Application Publication
(10) Pub. No.: US 2026/0086544 A1
(43) Pub. Date: Mar. 26, 2026

(54) DEVICE AND METHOD, IN PARTICULAR A COMPUTER-IMPLEMENTED METHOD, FOR DETERMINING THE EFFECT OF CHARACTERISTICS OF AN OBJECT, IN PARTICULAR OF A WORKPIECE, ON A RESULT OF AN OPERATION OF A TECHNICAL SYSTEM FOR INFLUENCING THE CHARACTERISTICS, IN PARTICULAR OF A PRODUCTION LINE

(71) Applicant: Robert Bosch GmbH, Stuttgart (DE)

(72) Inventors: Daan Roos, Amsterdam (NL); Sara Magliacane, Amsterdam (NL); Jan-Willem van de Meent, Utrecht (NL); Sebastian Gerwinn, Leonberg (DE)

(21) Appl. No.: 19/333,492

(22) Filed: Sep. 19, 2025

(30) Foreign Application Priority Data
Sep. 24, 2024 (DE) 10 2024 209 182.0

(51) Int. Cl. G05B 19/418

(52) U.S. Cl. CPC G05B 19/41885

(57) ABSTRACT

A device and method for determining the effect of characteristics of an object, in particular of a workpiece, on a result of an operation of a technical system for influencing the characteristics of a production line, for detecting a deviation of a physical property of the object from a target property or a cause of the deviation. Measured values are provided for the object. A data set is provided which comprises measured values provided for other objects. The measured values each quantify one of the characteristics of the particular object. Depending on the measured values, graphs are determined which characterize a causal relationship between the characteristics. Depending on the measured values and depending on the graphs, an estimation rule for estimating the effects of the characteristics, the relationship between which is characterized by the particular graph, on each other is determined for each graph.

### FIELD

The present invention relates to a device and a method, in particular a computer-implemented method, for determining the effect of characteristics of an object, in particular of a workpiece, on a result of an operation of a technical system for influencing the characteristics, in particular of a production line, for example for detecting a deviation of a physical property of the object from a target property or a cause of the deviation.

### BACKGROUND INFORMATION

Shapley values offer a way to explain anomalies or causes of anomalies or other quantifiable events in a technical system. Shapley values are described, for example, in Jianlong Zhou, Amir H. Gandomi, Fang Chen, and Andreas Holzinger; “Evaluating the quality of machine learning explanations: A survey on methods and metrics;” Electronicsweek, 10(593), 2021. ISSN 2079-9292. doi:10.3390/electronics10050593.

To determine Shapley values, causal knowledge of the technical system under consideration is required. One way of taking causal knowledge into consideration when determining Shapley values is described in Tom Heskes, Ioan Gabriel Bucur, Evi Sijben, and Tom Claassen; “Causal Shapley values: exploiting causal knowledge to explain individual predictions of complex models;” in Proceedings of the 34^{th} International Conference on Neural Information Processing Systems, NIPS'20, Red Hook, NY, USA, 2020. Curran Associates Inc. ISBN 978-1-71382-954-6. In order to take causal knowledge into consideration, knowledge about a causal sequence of available sensors and knowledge about the probability distributions underlying the causal knowledge is therefore required. These are estimated via a multivariate Gaussian distribution.

In practical applications where the knowledge required for this approach is not available, this approach cannot be used.

### SUMMARY

A method and A device according to the present invention offer an efficient way, in terms of computing resources, for determining the effect of characteristics of an object on a result of an operation of a technical system for influencing the characteristics without explicit assumptions being made about the underlying causal structures.

In addition, the method and device of the present invention are suitable for determining the effect for a greater number of characteristics than conventional approaches, while maintaining computing resources unchanged. The number of characteristics can be adapted to practical requirements in the method and device.

According to an example embodiment of the present invention, the method, in particular a computer-implemented method, for determining the effect of characteristics of an object, in particular of a workpiece, on a result of an operation of a technical system for influencing the characteristics, in particular of a production line, for example for detecting a deviation of a physical property of the object from a target property or a cause of the deviation, provides that measured values are provided for the object, in particular are measured on the object, wherein a data set is provided which comprises measured values provided for other objects, wherein the measured values each quantify one of the characteristics of the particular object, wherein, depending on the measured values, graphs are determined which characterize a causal relationship between the characteristics, wherein, depending on the measured values and depending on the graphs, an estimation rule for estimating the effects of the characteristics, the relationship between which is characterized by the particular graph, on each other is determined, wherein, for at least one subset of the characteristics, for the characteristics from the subset, with a model for predicting the effect of the other characteristics from the subset on the particular characteristic from the subset, depending on the estimation rule for the graph(s) which characterize the causal relationship between the characteristics from the subset, the prediction of the effects of the other characteristics from the subset on the particular characteristic from the subset is determined, and wherein for at least one characteristic from the subset the effect of the other characteristics is quantified depending on the predictions determined with the model for the at least one characteristic.

According to an example embodiment of the present invention, it can be provided that the measured values each characterize a result of a work step of the technical system, wherein, depending on the effects, a work step is selected from the work steps which has a greater effect than at least one other work step, and wherein the operation of the technical system is interrupted to influence the characteristic in the selected work step, or the deviation is detected in the selected work step, or the selected work step is detected as the cause of the deviation.

For the joint quantification of the effects, it can be provided that for several subsets, for each characteristic from the particular subset, the effect of the other characteristics from the particular subset is determined (208) depending on the prediction determined with the model for the particular characteristic from the particular subset, and wherein, for each characteristic, the effects of the other characteristics are quantified depending on the effects determined in the respective subsets for the particular characteristic.

The efficiency of the method is also increased by determining a set of graphs to which the same estimation rule applies, wherein a graph is selected from the set, wherein the estimation of the effects of the characteristics for the set of graphs with the same estimation rule is determined for the selected graph depending on the measured values and is used in the model as an estimate for the graphs from the set of graphs.

According to an example embodiment of the present invention, it can be provided that for at least one subset, the estimation rule is determined for each characteristic of the subset by setting a measured value that quantifies the particular characteristic and by varying the measured values that quantify the other characteristics from the subset.

It can be provided that, depending on the measured values, in particular acyclic causal graphs with mutually influencing characteristics as nodes are determined, wherein the particular graph has edges between nodes that connect mutually influencing characteristics and has no edges between mutually non-influencing characteristics.

The device for determining the effect of characteristics of an object, in particular of a workpiece, on a result of an operation of a technical system for influencing the characteristics, in particular of a production line, for example for detecting a deviation of a physical property of the object from a target property or a cause of the deviation, provides that the device has at least one processor and at least one memory, wherein the at least one memory stores instructions executable by the at least one processor, upon execution of which instructions by the at least one processor, the device carries out the method.

According to the present invention, a computer program can be provided, wherein the computer program comprises computer-readable instructions, during the execution of which by a computer the method of the present invention runs on the computer.

Further examples can be found in the following description and the figures.

### BRIEF DESCRIPTION OF THE DRAWINGS

FIG. 1 shows a device for determining the effect of characteristics of an object on a result of an operation of a technical system for influencing the characteristics, according to an example embodiment of the present invention.

FIG. 2 is a flowchart with steps of a method for determining the effect of characteristics of the object on the result of the operation of the technical system for influencing the characteristics, according to an example embodiment of the present invention.

### DETAILED DESCRIPTION OF EXAMPLE EMBODIMENTS

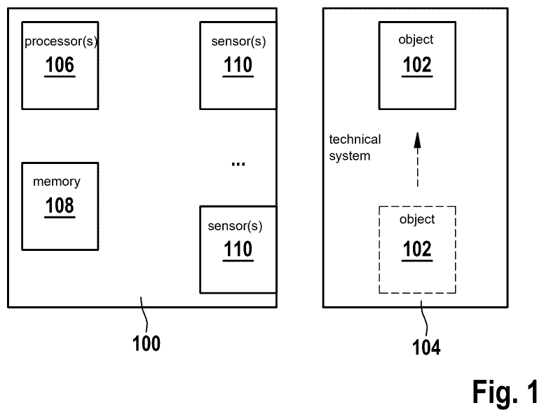

FIG. 1 schematically shows a device 100 for determining the effect of characteristics of an object 102 on a result of an operation of a technical system 104 for influencing the characteristics.

The technical system 104 is, for example, a production line. The production line includes, for example, several workstations.

The object 102 is, for example, a workpiece. The workpiece is processed, for example, on the production line. The workstations influence, for example, the characteristics of the workpiece.

The device 100 is designed, for example, to detect a deviation of a physical property of the object 102 from a target property.

The device 100 is designed, for example, to detect a cause of the deviation.

### Examples of Properties are:

Roughness of a surface of the object 102,
Thickness of a coating of at least a part of the object 102,
Diameter of a hole in the object 102,
Length of a side of a body of the object 102,
Angle between two sides of a body,
Depth of a milled recess in the object 102,
Angle of the hole or milled recess.

### Examples of Target Properties are:

Target roughness of a surface of the object 102,
Target thickness of a coating of at least a part of the object 102,
Target diameter of a hole in the object 102,
Target length of a side of a body of the object 102,
Target angle between two sides of a body,
Target depth of a milled recess in the object 102,
Target angle of the hole or milled recess.

The effect on the result of the operation of the technical system 104 is, for example, a pass or a fail of a technical check of the object 102, in particular of a test of compliance with the target properties at the end of the production line. For example, a pass is determined if the object 102 is suitable for its intended use. A fail is determined, for example, if the object 102 is unsuitable for its intended use.

The device 100 comprises at least one processor 106 and at least one memory 108.

The at least one memory 108 stores instructions executable by the at least one processor 106, which, when executed by the at least one processor 106, cause the device 100 to execute a method for determining the effect of characteristics of an object 102 on a result of an operation of a technical system 104 for influencing the characteristics.

The method is based on measurable characteristics.

The device 100 includes sensors 110 for measuring measured values that quantify the characteristics. For example, at least one sensor 110 is provided per workstation. For example, for each workstation at least one measured value of at least one characteristic is recorded which characterizes a property of the object 102 that is being produced or modified by the workstation.

For example, the measured values each characterize a result of a work step of the technical system 104. The work step is carried out, for example, by the production line, in particular by a workstation.

The characteristics are, for example, each assigned to one of the sensors 110. For example, an i-th characteristic is assigned to an i-th sensor 110.

The device 100 and method are used, for example, to quantify the effects that one characteristic has on the other characteristics. This makes it possible to create a model of the technical system 104 in which, for example, only the characteristics that have the greatest effects on the other characteristics are taken into account. The model of the technical system 104 can, for example, be used as a second data source in addition to the measured values. By comparing the values determined by the model of the technical system for the measured values with the measured values, an anomaly can be identified, for example, if the values and the measured values differ from each other by more than a specified tolerance.

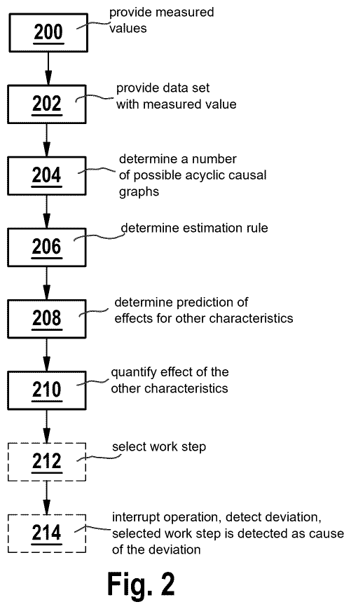

FIG. 2 shows a flowchart with steps of the method.

The method comprises a step 200.

In step 200, measured values x* are provided for the object 102 that quantify multiple characteristics S of the object 102. One measured value of the measured values x* quantifies, for example, one characteristic s∈S of the object 102. The measured values x* characterize multiple properties of the object 102. A measured value

$${x}_{i}^{*}$$

of the measured values x* for example quantifies a property of the object 102.

The measured values x* are measured, for example, on the object 102.

The method comprises a step 202.

In step 202, a data set

$$D = {\{ {x}^{( k )} \}}_{k = 1}^{d}$$

with measured values x^{(k)} from d other objects is provided. The measured values x^{(k)} of an object k, for example, quantify the same characteristics S as the measured values x* at the object 102. This means that the measured values x^{(k)} of the object k characterize the same properties as the measured values x* of the object 102.

This means that the measured values in the data set D each quantify one of the characteristics of the particular object k.

The method comprises a step 204.

In step 204, depending on the measured values, a number c of possible acyclic causal graphs G={G₁, . . . , G_{c}} with mutually influencing characteristics s∈S as nodes is determined.

The set of possible graphs is determined, for example, by means of a causal search algorithm that is designed to determine, from a set of |I| observations X={xᵢ}_{i∈I}, xᵢ ∈R^{d} that each comprise d measured values xᵢ, a set of possible acyclic causal graphs Gⱼ {Gⱼ=(V, E)_{j∈J}}.

An example of the causal search algorithm is the Fast Greedy Search (FGES). FGES is described in Chickering, D. M. (2002); “Optimal structure identification with greedy search;” Journal of Machine Learning Research, 507-554.

FGES uses a Bayesian information criterion:

$$BIC = 2 log ( P ( X \vert G ; θ ) ) - z \cdot k \cdot log ( \vert I \vert )$$

Here θ are parameters used to model the data distribution P (X|G, θ) (e.g. mean value and variances of the individual conditional distributions within the graph), and z is a constant. In FGES, for example, z=4 is used.

FGES is a Bayesian algorithm that heuristically searches the space of Bayesian networks and returns the model with the highest Bayesian score it finds. In particular, FGES starts its search with an empty graph. The algorithm then performs a stepwise forward search, adding edges between nodes in order to increase the Bayesian score. This process continues until no added edge increases the score. Finally, a backward search is performed, removing edges until no removed edge can increase the score. Since the edges within the resulting graph are not necessarily directed, the output of the algorithm can be interpreted as a set of graphs (where each possible direction corresponds to a graph in the set of possible graphs). In the example, the cyclic graphs are removed from the set of possible graphs because they indicate an implausible cyclic causal structure.

An example of the causal search algorithm is the PC algorithm described in Peter Spirtes, Clark N. Glymour, and Richard Scheines' “Causation, prediction, and search;” Adaptive Computation and Machine Learning. MIT Press, Cambridge, Mass, 2nd edition, 2000. ISBN 978-0-262-19440-2 [Spirtes, 2001].

An example of the causal search algorithm is the FGES algorithm in Joseph Ramsey, Madelyn Glymour, Ruben Sanchez-Romero, and Clark Glymour; “A million variables and more: the Fast Greedy Equivalence Search algorithm for learning high-dimensional graphical 398 causal models, with an application to functional magnetic resonance images;” International Journal of Data Science and Analytics, 3(2):121-129, March 2017. ISSN 2364-415X, 2364-4168. doi: 10.1007/s41060-016-0032-z.

The particular graph Gⱼ has edges between nodes that connect mutually influencing characteristics S. The particular graph Gⱼ has no edges between mutually non-influencing characteristics s.

The method comprises a step 206.

In step 206, depending on the graphs and depending on the measured values X_{S} per characteristic s, an estimation rule is determined for estimating the effect of the other characteristics on the particular characteristic s depending on the causal graphs.

The estimation rule is determined, for example, on a symbolic level without explicitly using a conditional probability defining the effects of the other characteristics on the particular characteristic.

The estimation rule is, for example, as described in Ilya Shpitser and Judea Pearl’ “Identification of conditional interventional distributions;” in Proceedings of the Twenty-Second Conference on Uncertainty in Artificial Intelligence, UAI'06, pages 437-444, Arlington, Virginia, USA, 2006. AUAI Press. ISBN 0-9749039-2-2, depending on the do calculus determined as

$${P}^{{G}_{j}} ( {X}_{\overline{S}} \vert do ( {X}_{S} = {x}_{s}^{*} ) ) .$$

For example, at least a set

$${G}_{S}^{l}$$

of causal graphs which have the same estimation rule P^{G}^{ⱼ} is determined.

The estimation rule p^{G}^{ⱼ} is determined, for example, per characteristic s from the subset S by setting the particular measured value

$${x}_{s}^{*}$$

that quantifies the particular characteristic s, and in particular by varying the measured values X_{S̅} that quantify the other characteristics.

For example, a set of graphs

$${G}_{S}^{l}$$

is determined depending on a selected subset of characteristics S. This means that, for a set S of subsets S, depending on the selected set of graphs

$${G}_{S}^{l}$$

and depending on the selected subset of characteristics S, for each subset S a graph Gⱼ is determined from the set

$${G}_{S}^{l} .$$

For example, the same estimation rule is used for the graphs from the set

$${G}_{S}^{l}$$

of graphs which has this same symbolic estimation rule P^{G}^{ⱼ} For example, the estimation rule is determined only once for a graph from the set

$${G}_{S}^{l}$$

and used for the other graphs from the set

$${G}_{S}^{l} .$$

The method comprises a step 208.

In step 208, for the characteristics s from the particular subset S, per characteristic s the prediction is determined of the effects of the other characteristics S̅ from the particular subset S on the particular characteristic s from the particular subset S.

The prediction for the particular characteristic s is determined, for example, with a model

$$f ( {X}_{\overline{S}} , {x}_{S}^{*} )$$

to predict the effect of the other characteristics S̅ from the subset Son the particular characteristic s. The model

$$f ( {X}_{\overline{S}} , {x}_{S}^{*} )$$

is defined depending on the estimation rule of the graph, which characterizes the causal relationship between the characteristic s and the other characteristics S̅ from the subset Sor defines this depending on the estimation rules of the graphs that characterize the causal relationship between the characteristic s and the other characteristics S̅ from the subset S. The prediction is determined, for example, depending on the measured values

$${x}_{S}^{*}$$

recorded for the particular characteristic s and on the measured values X_{S̅} recorded for the other characteristics S̅.

For example, for each characteristic s from the particular subset S the effect of the other characteristics S̅ from the particular subset S is determined depending on the data set D and depending on the prediction determined with the model ƒ for the particular characteristic s from the particular subset S.

The method comprises a step 210.

In step 210, for each characteristic s the effect of the other characteristics S̅ is quantified.

For example, per characteristic s∈S a value v^{G}^{ⱼ}(S) for the subset S is determined.

For example, per characteristic s the effect of the other characteristics is evaluated by an evaluation of the model ƒ using different combinations of measured values.

For example, for the characteristics s from the selected subset S, per characteristic s a conditional probability is in each case determined depending on the other characteristics S̅ from the selected subset S and depending on the selected representative Gⱼ of the set of graphs

$${G}_{S}^{l}$$

$${\hat{P}}_{{G}_{j}} ( {X}_{j} \vert {X}_{{Pa}_{{G}_{j} ( j )}} ) .$$

To determine the conditional probability

$${\hat{P}}_{{G}_{j}} ( {X}_{j} \vert {X}_{{Pa}_{{G}_{j} ( j )}} ) ,$$

a parametric form of the conditional probability

$${\hat{P}}_{{G}_{j}} ( {X}_{j} \vert {X}_{{Pa}_{{G}_{j} ( j )}} , θ )$$

is for example used, whereby θ parameters, e.g. a linear mapping of

$${X}_{{Pa}_{{G}_{j} ( j )}}$$

onto the parameters, represent conditional mean value and conditional variance of a parametric Gaussian form of the conditional probability. For example, a maximum likelihood estimation of the parameters is performed:

$$θ = arg {max}_{θ} {\prod }_{k} P ( {x}_{i}^{k} \vert {x}_{{P}_{{a}_{{x}_{i}}^{j}}}^{k} , θ )$$

For example, for the selected subset of characteristics S for the particular graph Gⱼ a value

$${v}^{{G}_{j}} ( S ) ← \frac{1}{D} {\sum }_{k = 1}^{D} \frac{{\prod }_{h ∉ S} \hat{P} ( {x}_{h}^{( k )} \vert {x}_{{Pa}_{{G}_{i} ( h ) ⋂ \overline{S}}}^{( k )} , {x}_{{Pa}_{{G}_{i} ( h ) ⋂ S}}^{*} )}{\hat{P} ( {X}_{\overline{S}}^{( k )} )} f ( {X}_{\overline{S}}^{( k )} , {x}_{S}^{*} )$$

is determined which quantifies the effects on the characteristics S according to the particular graph Gⱼ representative of the particular set of graphs

$${G}_{S}^{l} .$$

This means that the function is evaluated using different combinations of measured values. The combination is composed of the measured values of the data points k=1, . . . , D.

For example, the values are iteratively determined via possible subsets S of the characteristics s.

For example, the values are determined by iteration via the possible subsets S. This is useful for the most accurate approximation possible.

For example, a subset S is randomly drawn from the available characteristics. This means that the value v^{G}^{ⱼ}(S) is determined for the randomly drawn subset S of the characteristics s, rather than via the available characteristics. This is particularly useful for efficient calculation.

The function ƒ is specified, for example, on the basis of a functional description of the technical system 104.

The function ƒ is determined, for example, from the conditional probability distribution P(Y|X):

$$f ( X ) ∼ P ( Y \vert X )$$

Here Y represents an output variable that characterizes the result of the operation of the technical system 104. The output variable characterizes, for example, in the case of the workpiece, a measure of a measured or manually determined quality of the workpiece. The effect of the characteristics on the overall quality is thus evaluated.

For example, for the particular set S and the respective graphs Gⱼ the value v^{G}^{ⱼ}(S) is determined.

For example, depending on the values v^{G}^{ⱼ}(S) a list of vectors

$${\{ {Φ}^{{G}_{j}} \}}_{{G}_{j} ∈ G}$$

which quantify the effects is determined.

A vector Φ^{G}^{ⱼ} is determined, for example, by combining the values of the effects from the graphs Gⱼ ∈G in the vector Φ^{G}^{ⱼ}. For example, for each graph Gⱼ the estimated values v^{G}^{ⱼ}(S) of the particular subset S of characteristics s weighted with the weight

$$( \begin{matrix}p - 1 \\ \vert S \vert\end{matrix} )$$

for the particular subset S of characteristics s are added to a vector of the values V(Gⱼ).

For example, a new row is added to a binary matrix Z(Gⱼ), wherein the elements bᵢ of the row are determined as follows: (bᵢ=1, if i∈S, else 0).

For example, for each graph Gⱼ causal Shapley values W(Gⱼ) are determined as:

$$Φ ( {G}_{j} ) = {( {Z ( {G}_{j} )}^{T} diag ( W ( {G}_{j} ) ) Z ( {G}_{j} ) )}^{- 1} {Z ( {G}_{j} )}^{T} diag ( W ( {G}_{j} ) ) V ( {G}_{j} )$$

The particular vector Φ^{G}^{ⱼ} indicates the contribution of all characteristics to the effect. This means that the i-th dimension of the vector Φ^{G}^{ⱼ} indicates the contribution of the i-th characteristic.

For example, the list of vectors

$${\{ {Φ}^{{G}_{j}} \}}_{{G}_{j} ∈ G}$$

is output.

For example, the values of the effects as described in Scott M. Lundberg and Su-In Lee; “A unified approach to interpreting model predictions;” in Proceedings of the 31st International Conference on Neural Information Processing Systems, NIPS'17, pages 4768-4777, Red Hook, NY, USA, 2017. Curran Associates Inc. ISBN 978-1-5108-394 6096-4 [Lundberg and Lee, 2017] are combined in the vector Φ^{G}^{ⱼ}.

For example, for each subscript i=1, . . . , p the maximum value and the minimum value are determined via the respective vectors Φ^{G}^{ⱼ}, and output as a possible range of values for the effect that the characteristic with subscript i has on the other characteristics.

The measured values

$${x}_{S}^{*}$$

in each case characterize, for example, a result of a work step of the technical system 104.

To influence a characteristic s in one of the work steps, or to detect the deviation in one of the work steps, or to detect one of the work steps as the cause of the deviation, the method may comprise further steps.

The method for example comprises a step 212.

In step 212, depending on the effects, a work step that has a greater effect than at least one other work step is selected from the work steps. The work steps are, for example, assigned to the respective characteristics s to the production or modification of which the particular work step leads.

For example, the work step is selected that is assigned to the characteristic for which most of the vectors Φ^{G}^{ⱼ} from list of vectors {Φ^{G}^{ⱼ}}_{G}_{ⱼ}_{∈G} have the greatest value. For example, if the largest values are the same, the work steps with the same values are selected.

The method for example comprises a step 214.

In step 214, for example, the operation of the technical system 104 for influencing the characteristic s is interrupted in the selected work step.

In step 214, for example, the deviation in the selected work step is detected.

In step 214, for example, the selected work step is detected as the cause of the deviation.

An algorithm of an exemplary implementation of the method is based on available characteristics, that is to say e.g. characteristics measured on the technical system 104. The algorithm provides the data set

$$D = {\{ {x}^{( k )} \}}_{k = 1}^{d} ,$$

the model ƒ, and the measured values x* of the available characteristics as input variables. The algorithm provides a number of combinations n_{comb}≤2^{[p]} to be considered, wherein p is a predefined parameter that indicates the number of characteristics to be considered from the available characteristics, e.g. p=100, p=500, or p=1000. The algorithm includes the following steps:

1: Initialize a set S of subsets S of characteristics being considered S←{Ø, [p]} according to the procedure described in [Lundberg and Lee, 2017].

2: Extract n_{comb}−2 subsets S of the power 2^{[p]}{Ø,[p]} with a probability equal to the weights

$$k ( S ) = \frac{( p - 1 )}{( \begin{matrix}p \\ \vert S \vert\end{matrix} ) \vert S \vert ( p - \vert S \vert )}$$

of a kernel k defined according to [Lundberg and Lee, 2017], from the available characteristics and add the extracted characteristics to the set S.

3: Learn the in particular acyclic causal graphs Gⱼ, in particular the number c of acyclic causal graphs Gⱼ, as a Markov equivalence class (MEC) G={G₁, . . . , G_{c}} by applying a causal search function to the data set D, for example according to [Spirtes, 2001].

4: For each subset S∈S of characteristics execute:

5: For each graph Gⱼ execute:

6: Identify the estimation rule for

$${P}^{{G}_{j}} ( {X}_{\overline{S}} \vert do ( {X}_{S} = {x}_{S}^{*} ) ) ,$$

especially with the ID algorithm described in Ilya Shpitser and Judea Pearl; “Identification of conditional interventional distributions;” in Proceedings of the Twenty-Second Conference on Uncertainty in Artificial Intelligence, UAI'06, pages 437-444, Arlington, Virginia, USA, 2006. AUAI Press. ISBN 0-9749039-2-2.

7: End of the execution for each graph Gⱼ.

8: Group the graphs Gⱼ with the same estimation rule in each case in one set

$${G}_{S}^{l} .$$

9: End of execution for each subset S∈S of characteristics.

10: For each subset S∈S of characteristics execute:

11: Determine the predictions

$${\{ f ( {X}_{\overline{S}}^{( k )} , {x}_{S}^{*} ) \}}_{k = 1}^{D}$$

with the measured values

$${\{ {X}_{\overline{S}}^{( k )} \}}_{k = 1}^{D}$$

and the measured values

$${x}_{S}^{*}$$

12: For each set of graphs

$${G}_{S}^{l}$$

execute:

13: Choose any graph Gⱼ from the set

$${G}_{S}^{l}$$

14: Estimate the conditional probabilities

$${\hat{P}}_{{G}_{j}} ( {X}_{j} \vert {X}_{{Pa}_{{G}_{j} ( j )}} )$$

on the measured values from the data set D

15: Determine the value v for the graph Gⱼ and the subset S:

$${v}^{{G}_{j}} ( S ) ← \frac{1}{D} {\sum }_{k = 1}^{D} \frac{{\prod }_{h ∉ S} \hat{P} ( {x}_{h}^{( k )} \vert {x}_{{Pa}_{{G}_{i} ( h ) ⋂ \overline{S}}}^{( k )} , {x}_{{Pa}_{{G}_{i} ( h ) ⋂ S}}^{*} )}{\hat{P} ( {X}_{\overline{S}}^{( k )} )} f ( {X}_{\overline{S}}^{( k )} , {x}_{S}^{*} )$$

16: Save the value v^{G}^{ⱼ}(S) for the other graphs G_{i,i≠j}, from the set

$${G}_{S}^{l} ,$$

in particular as the particular value v^{G}^{_{i,i≠j}}(S)

17: End of execution for each set

$${G}_{S}^{l}$$

18: End of execution for each subset S∈S of characteristics

19: For each graph Gⱼ ∈G execute:

20: Collect all values for all subsets S⊆S in a vector v^{G}^{ⱼ}←(v^{G}^{ⱼ}(Ø), . . . , v^{G}^{ⱼ}([p]))

21: Determine the vector Φ^{G}^{ⱼ} for S with v^{G}^{ⱼ} especially according to [Lundberg and Lee, 2017]

22: End of execution for each graph Gⱼ∈G

23: Output the list of vectors {Φ^{G}^{ⱼ}}_{G}_{ⱼ}_{∈G} for each graph Gⱼ, in the MEC G.

1-8. (canceled)

9. A computer-implemented method for determining an effect of characteristics of an object, including a workpiece, on a result of an operation of a technical system for influencing characteristics of a production line, the method comprising the following steps:
providing measured values for the object measured on the object;
providing a data set includes measured values provided for other objects, wherein each of the measured values quantify a characteristics of a respective object of the object and the other objects;
determining, depending on the measured values for the object and for the other objects, graphs which characterize a causal relationship between the characteristics of the respective objects;
determining, for each of the graphs, depending on the measured values and depending on the graphs, an estimation rule for estimating effects of the characteristics, whose causal relationship is characterized by the graph, on each other;
for each respective characteristic of at least one subset of the characteristics, determining a prediction of effects, on the respective characteristic, of the other characteristics from the subset, using a model for predicting the effects of the other characteristics from the subset on the respective characteristic, depending on the estimation rule for the graphs which characterize the causal relationship between the characteristics from the subset; and
quantifying, for at least one characteristic from the subset, the effect of the other characteristics depending on the predictions determined with the model for the at least one characteristic.

10. The method according to claim 8, wherein the method detects a deviation of a physical property of the object from a target property, or a cause of the deviation,

11. The method according to claim 9, wherein the measured values of the object and the other objects each characterize a result of a work step of the technical system, wherein, depending on the effects, a work step is selected from the work steps which has a greater effect than at least one other work step, and wherein: (i) the operation of the technical system is interrupted to influence the characteristic in the selected work step, or (ii) a deviation is detected in the selected work step, or (iii) the selected work step is detected as a cause of the deviation.

12. The method according to claim 9, wherein for each respect subset of several subsets of the characteristics, for each respective characteristic from the respective subset, the effect of the other characteristics from the respective subset is determined depending on the prediction determined with the model for the respective characteristic from the respective subset, and wherein, for each respective characteristic, the effects of the other characteristics are quantified depending on the effects determined in the respective subsets for the respective characteristic.

13. The method according to claim 9, wherein a set of graphs is determined to which the same estimation rule applies, wherein a graph is selected from the set of the graphs, wherein the estimation of the effects of the characteristics for the set of graphs with the same estimation rule is determined for the selected graph depending on the measured values and is used in the model as an estimate for the graphs from the set of graphs.

14. The method according to claim 9, wherein for at least one subset, the estimation rule is determined for each respective characteristic of the subset by setting a measured value that quantifies the respective characteristic and by varying the measured values that quantify the other characteristics from the subset.

15. The method according to claim 9, wherein, depending on the measured values, acyclic causal graphs with mutually influencing characteristics as nodes are determined, wherein each of the causal graphs has edges between nodes that connect mutually influencing characteristics and has no edges between mutually non-influencing characteristics.

16. A device for determining an effect of characteristics of an object including a workpiece, on a result of an operation of a technical system for influencing characteristics of a production line, the device comprising:
at least one processor; and
at least one memory, wherein the at least one memory stores instructions executable by the at least one processor, and upon execution of the instructions by the at least one processor, the device carries out a method for determining an effect of characteristics of an object, including a workpiece, on a result of an operation of a technical system for influencing characteristics of a production line, the method comprising the following steps:
providing measured values for the object measured on the object,
providing a data set includes measured values provided for other objects, wherein each of the measured values quantify a characteristics of a respective object of the object and the other objects,
determining, depending on the measured values for the object and for the other objects, graphs which characterize a causal relationship between the characteristics of the respective objects,
determining, for each of the graphs, depending on the measured values and depending on the graphs, an estimation rule for estimating effects of the characteristics, whose causal relationship is characterized by the graph, on each other,
for each respective characteristic of at least one subset of the characteristics, determining a prediction of effects, on the respective characteristic, of the other characteristics from the subset, using a model for predicting the effects of the other characteristics from the subset on the respective characteristic, depending on the estimation rule for the graphs which characterize the causal relationship between the characteristics from the subset, and
quantifying, for at least one characteristic from the subset, the effect of the other characteristics depending on the predictions determined with the model for the at least one characteristic.

17. The device according to claim 16, wherein the device is configured to detect a deviation of a physical property of the object from a target property or a cause of the deviation.

18. A non-transitory computer-readable medium on which is stored a computer program including computer-readable instructions for determining an effect of characteristics of an object, including a workpiece, on a result of an operation of a technical system for influencing characteristics of a production line, the instructions, when executed by a computer, causing the computer to perform the following steps:
providing measured values for the object measured on the object;
providing a data set includes measured values provided for other objects, wherein each of the measured values quantify a characteristics of a respective object of the object and the other objects;
determining, depending on the measured values for the object and for the other objects, graphs which characterize a causal relationship between the characteristics of the respective objects;
determining, for each of the graphs, depending on the measured values and depending on the graphs, an estimation rule for estimating effects of the characteristics, whose causal relationship is characterized by the graph, on each other;
for each respective characteristic of at least one subset of the characteristics, determining a prediction of effects, on the respective characteristic, of the other characteristics from the subset, using a model for predicting the effects of the other characteristics from the subset on the respective characteristic, depending on the estimation rule for the graphs which characterize the causal relationship between the characteristics from the subset; and
quantifying, for at least one characteristic from the subset, the effect of the other characteristics depending on the predictions determined with the model for the at least one characteristic.
